(19) United States
(12) Patent Application Publication
(10) Pub. No.: US 2011/0258563 A1
(43) Pub. Date: Oct. 20, 2011

(54) Automatic Screen Zoom Level

(76) Inventor: Scott David Lincke, Rockville, MD (US)

(21) Appl. No.: 12/762,775

(22) Filed: Apr. 19, 2010

(51) Int. Cl. G06F 3/048; G06F 3/01

(52) U.S. Cl. 715/760; 715/800

(57) ABSTRACT

The invention automatically controls the zoom level of a web browser to optimize its use with the current web page and display device. When the web browser requests content from a web server by sending the URL of the content over its data connection, a client zoom level manager module detects this request and sends a second request to the server zoom level control module running on a server. While the web server responds to the first request, the server zoom level control module determines if preferred zoom level settings are stored for the URL information that it received. Preferred zoom level settings are sent from the server zoom level control module to the client. The client zoom level manager module uses the received information to adjust the web browser's zoom level to reflect the preferred zoom level settings so optimal web page viewing is enabled without manual user intervention.

### CROSS REFERENCE TO RELATED APPLICATIONS

Provisional Application 61172804

This application claims priority from U.S. Provisional Patent Application Ser. No. 61/176,122, entitled “Automatic Screen Zoom Level”, filed on 7 May 2009. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to software. More specifically, the present invention relates to a method of automatically managing the screen zoom level of web pages viewed with a web browser.

### BACKGROUND OF THE INVENTION

During web browsing, users sometimes desire to adjust the zoom level of a given web page in order to see details better or adjust the portion of their screen that is occupied by the viewed web page. Most popular web browsers include a zoom level feature. The feature enlarges some or all of the content displayed when the user activates the zoom-in command and reduces the size of some or all the content displayed when the user activates the zoom-out command. Prior art screen zoom level tools are generally manual in function, requiring user intervention to activate them in many situations. When a user decides that they need to adjust the zoom level of their currently displayed web page, they use a keyboard control or activate an on screen control to zoom in or out of the given web page. While this manual mechanism is reasonably effective for environments where zooming is infrequently used, it is unsatisfactory for use situations in which zoom level adjustment is desired for many, most or all web pages viewed. For example, manual zoom level adjustment may be commonly desired for web pages being viewed on an HDTV, where adjusting the zoom level to fill the entire screen is important. It may also be commonly desired for pages being viewed on a touch screen, where adjusting the zoom level to be able to tap links on the screen is important. Manual zoom level adjustment using the prior art is particularly inconvenient in situations where a physical keyboard or mouse is not convenient to use or by individuals challenged by the interaction required by physical input devices. Minimizing user input required to optimize the screen zoom level of a given web page to the display is an important aspect of usability that the prior art does not address adequately. These deficiencies cause a burden to the user by forcing the user to manually manage the zoom level more frequently in order to interact with the web page. Some prior art reduces the issue by remembering and automatically applying the manually configured zoom level for an already accessed web page, but it requires the user to manually configure the zoom level for each web page or web domain during a previous visit.

What is needed is a system-managed zoom level adjustment so that web pages automatically appear set to the correct zoom level each and every time the web page is accessed. The solution should set the zoom level without user intervention for web pages, even on the first visit to the web page or web site and automatically use a new optimal setting if the web page changes in layout such that a different zoom level is optimal than that which was optimal during the last visit. Such as solution would provide a distinct advantage over the prior art to all users, but particularly those users that are disabled, using less convenient input devices like touch screens or limited function remote controls, or using HDTVs.

Therefore what is needed is a method for automatically controlling the zoom level setting of a web browser in a way which allows users to access various websites and interact with content zoomed to an optimal level while requiring minimal manual user interaction.

### BRIEF SUMMARY OF THE INVENTION

The present invention is a method of automatically managing the zoom level used to display a web page by a web browser. The present invention optimizes the zoom level to the specific screen resolution of the display device.

The advantages of the present invention include, without limitation, the ease with which it allows users to access various websites and view them displayed optimally regardless of screen resolution while requiring minimal manual user interaction. This presents usability advantages over current zoom level adjustments enabled in web browsers that support zoom level adjustment, but require manual configuration. It presents an even greater advantage for users that are challenged in interacting with the web browser device, such as the disabled or those using display resolutions that are not commonly used on web browser PCs, or computers with less convenient input devices like touch screens or HDTVs.

### BRIEF DESCRIPTION OF THE SEVERAL VIEWS OF THE DRAWING

The accompanying drawings, which are incorporated herein and form a part of the specification, illustrate the present invention and, together with the description, further serve to explain the principles of the invention and to enable a person skilled in the pertinent art to make and use the invention.

FIG. 1 is an overall software architecture view of the present invention;

FIG. 2 is a flow diagram illustrating the client and server processing of an automatic adjustment of the zoom level settings;

FIG. 3 is an illustration showing the controls used in manual adjustment of the zoom level settings;

FIG. 4 is a flow diagram illustrating the client and server processing of manual adjustment of the zoom level settings.

FIG. 5 illustrates an example web page which was designed for a lower screen resolution than the user's web browsing display;

FIG. 6 illustrates an example web page which includes a text that would not be visible from across the room on a TV web browser unless the zoom level is adjusted;

FIG. 7 illustrates an example web page which includes links that would not be easily used with a touch screen web browser unless the zoom level is adjusted; and

FIG. 8 is a flow chart illustrating the process of the present invention for providing automatic zoom level adjustment.

### DETAILED DESCRIPTION OF THE INVENTION

In the following are detailed descriptions of the invention of exemplary embodiments. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

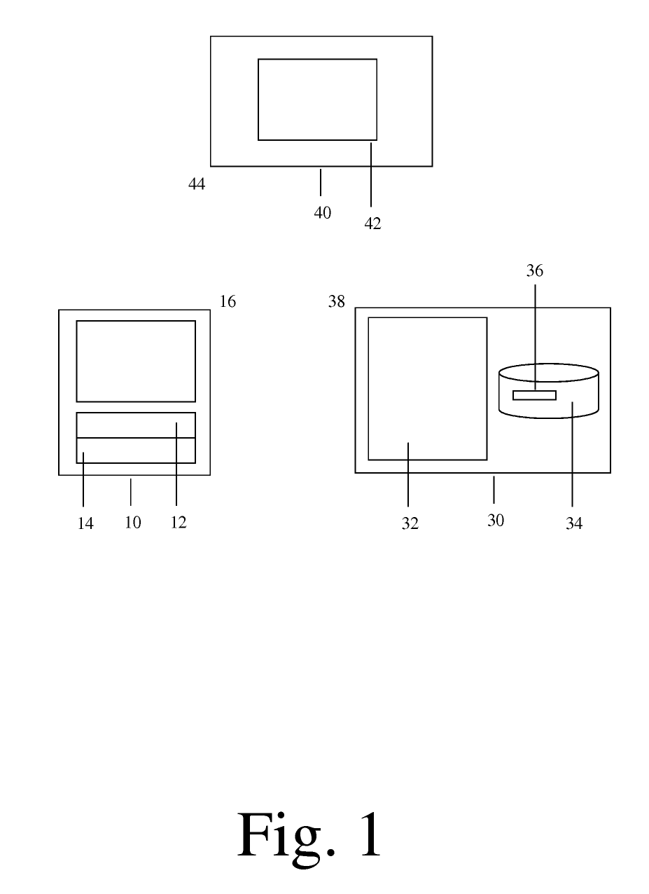

Referring now to the invention in more detail, in FIG. 1 there is shown a client computing device 10 having a web browser 12, a client zoom level manager module 14, and a data connection 16. A server computing device 30 is also shown having a server zoom level control module 32, a data storage device 34, stored preferred zoom level settings 36 that includes URL-specific information about the optimal zoom level of web browser 12, and a data connection 38 that allows it to send and receive messages to and from client computing device 10. The optimal zoom level setting is stored as a value or percentage relative to 1.00 or 100%, the browser zoom setting needed display the content relative to a standard size (e.g. 1024 pixel width) screen. The client zoom level manager module 14 adjusts the preferred zoom level setting received to the specific value to be used on the user's web browser by multiplying the preferred zoom level times a value representing the user's screen width and dividing the product by the standard size (e.g. 1024 pixels). This zoom level factor is then used to set the web browser zoom level. Also, a web-server computing device 40 is shown with web server software 42 and a data connection 44 that allows it to send and receive messages to and from client computing device 10.

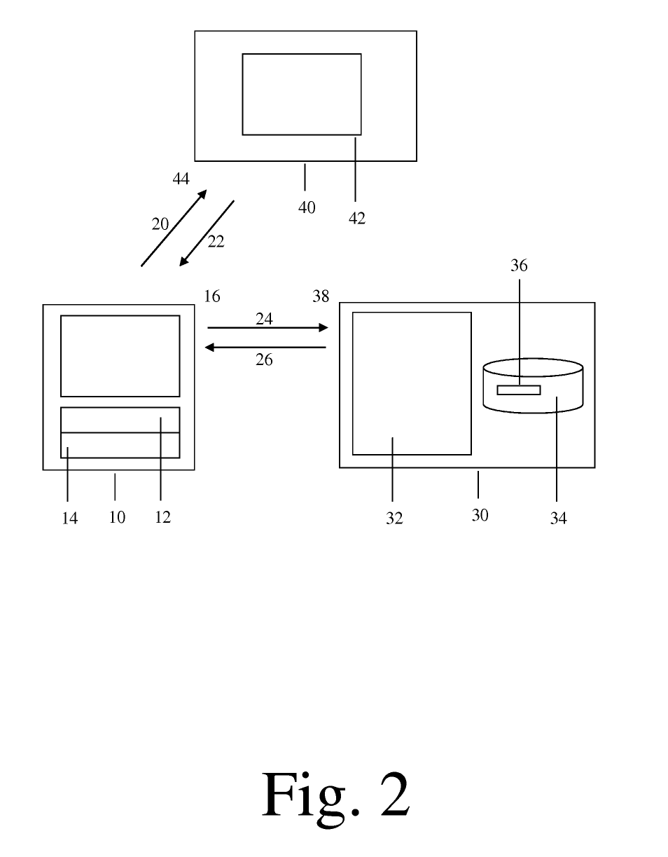

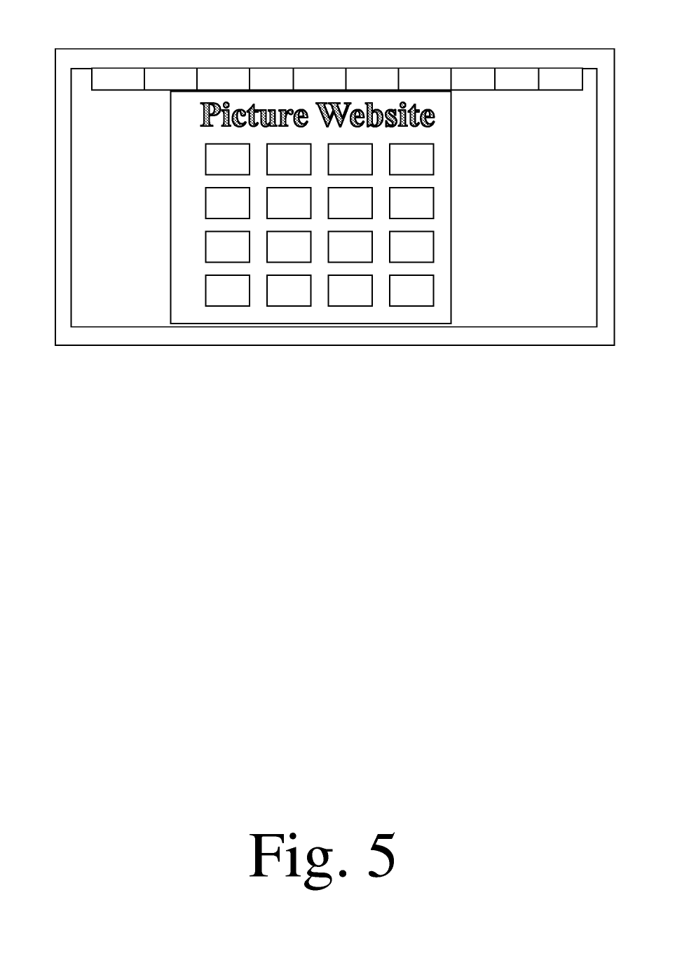

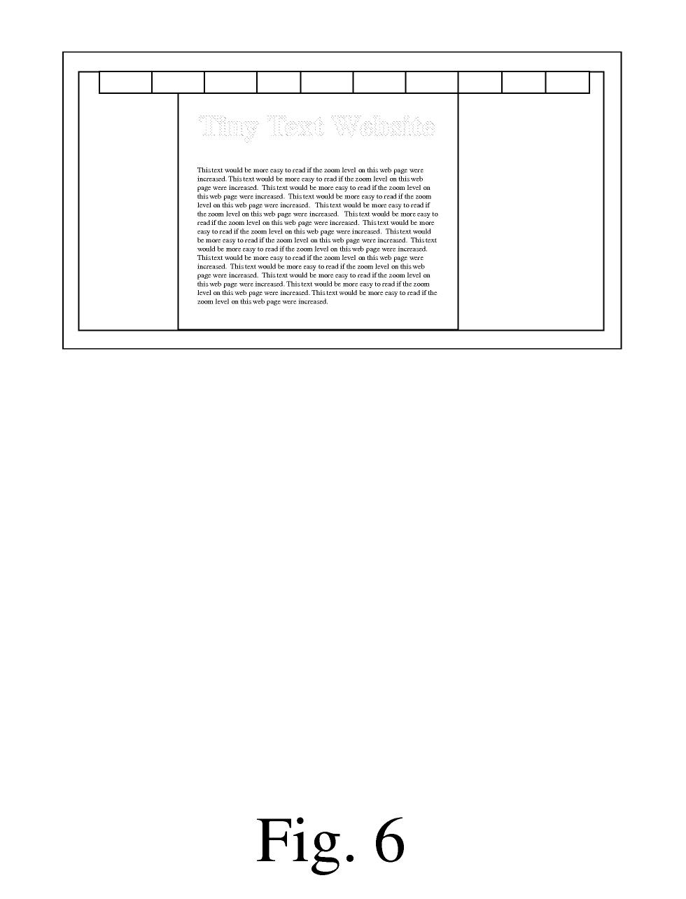

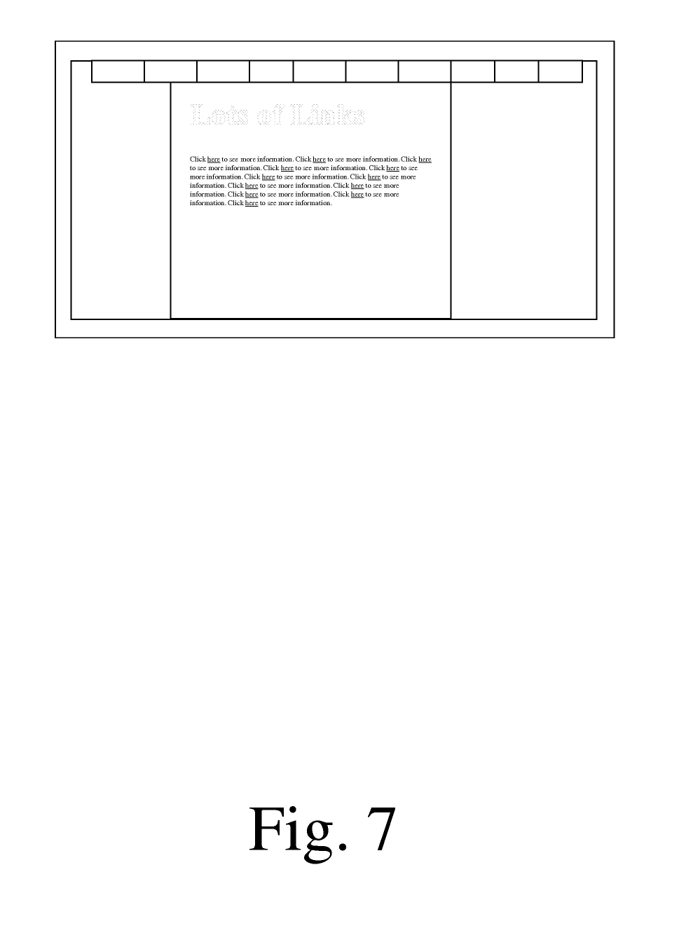

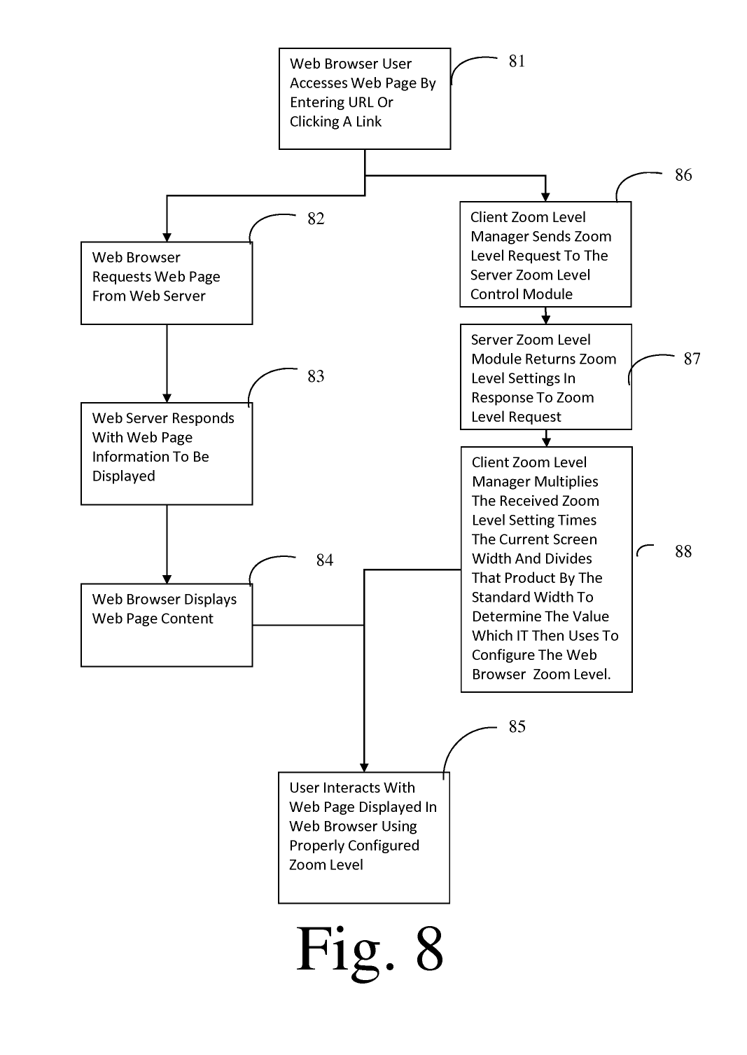

FIGS. 2 and 8 illustrate the automatic control of the on-screen zoom level 50. When a user of the client device 10 uses the web browser 12 to trigger the request of content from a web server computing device 40 by sending a web request 20, including the URL of the content, over its data connection 16 in step 81, the client zoom level manager module 14 detects this request and sends a zoom level request 24 with the content URL to the server zoom level control module 32 in step 86 running on server computing device 30. The web server computing device 40 responds in step 83 to the request it received in steps 81 and 82 by sending the requested and retrieved content in web response 22 to client device 10 for processing by the web browser 12. The server zoom level control module 32, in step 87, running on server computing device 30 determines if preferred zoom level settings 36 are stored in data storage device 34 for the URL that it received from the client zoom level manager module 14. If preferred zoom level settings 36 are found, they are sent from the server zoom level control module 32 to the client zoom level manager module 14 running on client computing device 10 in the zoom level response 26 in step 87. The client zoom level manager module 14, in step 88, adjusts the received preferred zoom level setting 36 using the to the specific value to be used on the user's web browser by multiplying the preferred zoom level times a value representing the user's screen width and dividing the product by the standard width (e.g. 1024 pixels). This zoom level factor is then used to set the zoom level 50 on the web browser 12 content displayed in step 84. Finally, a user interacts with the web page displayed in the web browser using a properly configured zoom level in step 85. FIG. 5, FIG. 6, and FIG. 7 illustrate examples of web pages that can benefit from this invention. FIG. 5 illustrates a web page is designed for a lower horizontal resolution than the screen on which it is displayed. Unless the zoom level is adjusted, much of the display is unused and wasted in showing this web page. High resolution HDTV displays may show web pages designed for 800 or 1024 pixel widths this way, with little or no useful data displayed on the left and right sides of the screen. In this case the preferred zoom level settings 36 stored in the data storage device 34 can include values to specify that the zoom level 50 should be set to a higher value, selected to scale the screen the precise amount needed to show the entire width of the web page on the screen. FIG. 6 illustrates a web page that includes text that is too small to be viewed from across the screen with a web browser used on an HDTV. In this case the preferred zoom level settings 36 stored in the data storage device 34 can include values to specify that the zoom level 50 may be even higher than that needed to fill the screen, sacrificing visibility of some portion of the screen in order to make the text news stores shown on the page readable from across the room on an HDTV web browser. FIG. 7 illustrates a web page that includes links that a user with a touch screen would like to be able to tap to follow the link. In this case the preferred zoom level settings 36 stored in the data storage device 34 can include values to specify that the on-screen zoom level 50 should be high enough to expand the links to be easily tapped by a user.

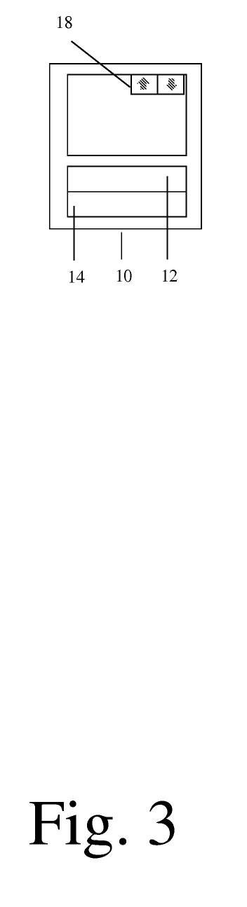

FIG. 3 illustrates that the manual zoom level control 18 includes two buttons to increase or decrease the zoom level 50 of the screen in the web browser 12. This feature of the client zoom level manager module 14 allows users to manually set the zoom level 50 in the web browser 12 running on the client computing device 10. When a user selects one of these buttons, the client zoom level manager module 14 detects the input and increases or decreases the zoom level 50 setting value used by the web browser 12, depending on which button is selects.

In further detail, referring back to the invention of FIG. 1, the data connection speed, including both data bit-rate and latency, between client computing device 10 and server computing device 30 as well as the processing performance of the server zoom level control module 32 must be sufficient that the client zoom level manager module 14 is able to set the zoom level 50 to the preferred zoom level settings 36 in the web browser 12 quickly enough for the user to benefit. In addition to data connection speed, the processing performance of the server computing device 30 and the server data storage 34 must be adequate to respond to queries quickly.

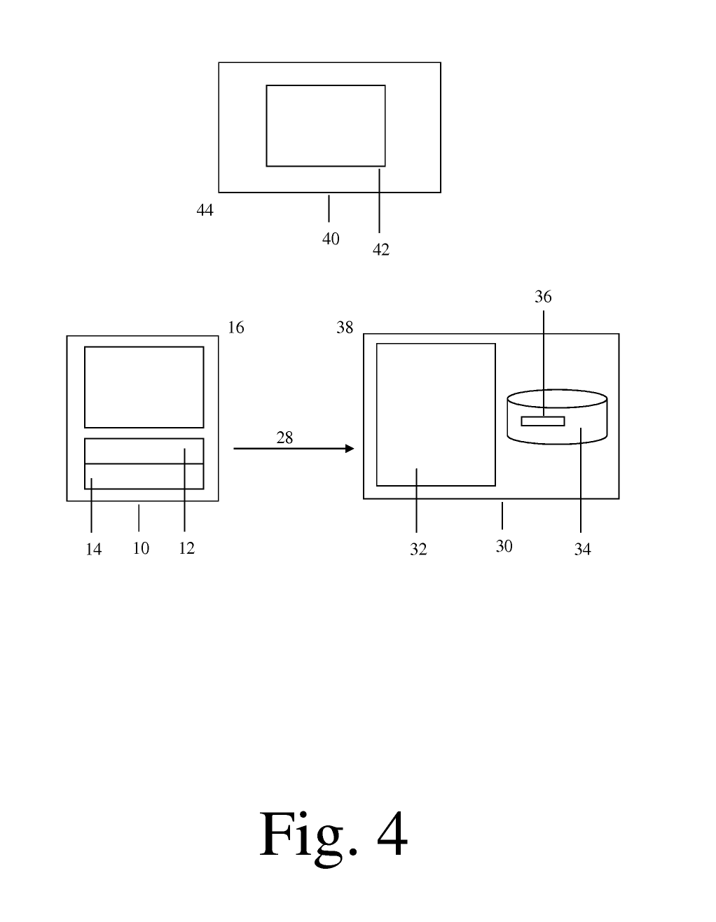

The construction details of the invention as shown in FIG. 1 illustrate a client zoom level manager module 14 that is separate from the web browser 12, but the client zoom level manager module 14 of course can be integrated into the web browser 12. The construction details of the invention describe preferred zoom level setting as a percentage value that is relative to a standard size and must be adjusted by the client zoom level manager module to be applied to a specific screen. The value could of course be stored as a series of values preconfigured for various screen sizes or calculated on the server prior to being sent to the client. The construction details, as shown in FIG. 1, illustrate a web browser 12 integration including access to web server software 42, but other client integration and access to other server sources of course could be used. The controls shown in FIG. 3 show two zoom level icon buttons used for the manual zoom level control 18, but other on-screen controls and inputs, like physical buttons on a remote control or mouse, of course could be used. The construction details shown in FIG. 2 show preferred zoom level settings 36 specific to a URL, but less specific web location information like a domain name could of course also be used. FIG. 4 illustrates an optional refinement of the invention in which manual use of the zoom level controls 18 are sent in a zoom level feedback message 28 to the server zoom level control module 32 so it can update the preferred zoom level settings 36 with the manually set zoom level so that this information can be later retrieved by other users.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

I claim:

1. A computer readable medium having computer executable instructions, that when executed by a computer causes the computer to perform a method for automatically adjusting the zoom level of the web page displayed in the web browser:
providing a client computing device having a web browser;
providing a client zoom level manager module;
providing a data connection;
providing a server computing device having a server zoom level control module;
providing a data storage device;
storing preferred zoom level settings on the data storage device;
providing a data connection between the client computing device and the server computing device;
sending and receiving messages to and from the client computing device and the server computing device;
providing a web-server computing device with a web server software;
allowing the web-server computing device to send and receive messages to and from the client computing device via the data connection; and
specifying the zoom level for the web browser.

2. The method for automatically adjusting the zoom level of the web browser of claim 1, further comprising the steps of:
sending a web request, including the URL of the content over the data connection by the web browser;
requesting content from the web server computing device over the data connection;
detecting the request by the client zoom level manager;
sending a zoom level request with the content URL to the server zoom level control module running on the server computing device by the client zoom level manager;
responding by the web server computing device to the request;
sending the requested and retrieved content in a web response by the web server computing device to the client device for processing by the web browser;
determining by the server zoom level control module running on the server computing device if preferred zoom level settings are stored in the data storage device for the URL that was received from the client zoom level manager module;
if the preferred zoom level settings are found, they are sent from the server zoom level control module to the client zoom level manager module running on the client computing device in the zoom level response; and
if the preferred zoom level settings are not found, default settings are sent;
using the received preferred zoom level settings by the client zoom level manager module to adjust the browser zoom level so that the preferred zoom level is used to display the web page; and
interacting with the web page displayed in the web browser using a properly configured zoom level.

3. The method for automatically adjusting the zoom level of the web browser of claim 2, further comprising the step of:
determining the specific zoom level for the next web page; and
automatically adjusting the zoom level by the client zoom level manager module either at a specific zoom level or at its last level.

4. The method for automatically adjusting the zoom level of the web browser of claim 1, further comprising the step of:
specifying the zoom level as a percentage scaling factor; or
specifying the zoom level relative to its current value.

5. The method for automatically adjusting the zoom level of the web browser of claim 4, further comprising the steps of:
specifying a minimum zoom level such that no lower zoom level is used; or
specifying a maximum zoom level such that no higher zoom level is used.

6. The method for automatically adjusting the zoom level of the web browser of claim 1, further comprising the steps of:
sending feedback messages from the client to the server;
providing information about how the user interacts with the zoom level via the feedback messages; and
using the provided information to update the preferred zoom level setting for a given URL.

7. The method for automatically adjusting the zoom level of the web browser of claim 6, further comprising the step of:
updating from the client to the server as the feedback is received.

8. The method for automatically adjusting the zoom level of the web browser of claim 7, further comprising the steps of:
sending either immediately or delayed/batched feedback to the server; and
sending updates from the client to the server either grouped with other information that may be related or unrelated to the zoom level information.

9. The method for automatically adjusting the zoom level of the web browser of claim 1, further comprising the step of:
storing preferred zoom level settings that includes URL-specific information about the zoom level value by the data storage device.

10. The method for automatically adjusting the zoom level of the web browser of claim 9, wherein
the zoom level is not changed for popup dialog boxes shown on the web browser.

11. The method for automatically adjusting the zoom level of the web browser of claim 1, further comprising the steps of:
locating locally the server zoom level control module and the data storage device on the client device;
sending a web request, including the URL of the content over the data connection by the web browser;
requesting content from the web server computing device over the data connection;
detecting the request by the client zoom level manager;
sending a zoom level request with the content URL to the server zoom level control module running on the local client device by the client zoom level manager;
responding by the web server computing device to the request;
sending the requested and retrieved content in a web response by the web server computing device to the client device for processing by the web browser;
determining by the server zoom level control module running on the local client device if preferred zoom level settings are stored in the data storage device for the URL that was received from the client zoom level manager module;
if the preferred zoom level settings are found, they are sent from the server zoom level control module to the client zoom level manager module running on the client computing device in the zoom level response;
using the received preferred zoom level settings by the client zoom level manager module to adjust the browser zoom level so that the preferred zoom level is used to display the web page;
interacting with the web page displayed in the web browser using a properly configured zoom level;
retrieving the preferred zoom level settings without sending information over a network; and
loading the set of preferred zoom level settings into the data storage device during periodic data retrievals.

12. The method for automatically adjusting the zoom level of the web browser of claim 1, further comprising the steps of:
providing manual zoom level control;
displaying control buttons to increase and decrease the zoom level value on the screen in the web browser running on the client computing device; and
selecting the control, the client zoom level manager module detects the input and adjusts the zoom level in the web browser.

13. The method for automatically adjusting the zoom level of the web browser of claim 12, wherein other on-screen controls and physical inputs are provided as a means for manually adjusting the zoom level.

14. The method for automatically adjusting the zoom level of the web browser of claim 1, wherein the client zoom level manager module is integrated into the web browser.

15. The method for automatically adjusting the zoom level of the web browser of claim 1, further comprising the step of:
storing preferred zoom level settings that include non-URL-specific information about the zoom level by the data storage device

16. The method for automatically adjusting the zoom level of the web browser of claim 1, further comprising the steps of:
submitting, in a zoom level feedback message to the server zoom level control module, manual use of the zoom level control; and
updating the preferred zoom level settings by the server zoom level control module, so that this information can be used as the preferred zoom level settings.

17. The method for automatically adjusting the zoom level of the web browser of claim 1, further comprising the steps of:
using the web browser to trigger a request of content from a web server computing device;
sending a web request by the web browser, including the URL of the content, over the webs browser's data connection;
detecting this request by the client zoom level manager module;
sending a zoom level request with the content URL to the server zoom level control module running on the server computing device;
responding to the request by the web server computing device;
sending the requested content in a web response to a client device for processing by the web browser;
determining by the server zoom level control module running on server computing device if preferred zoom level settings are stored in the data storage device for the URL that it received from the client zoom level manager module;
sending preferred zoom level settings from the server zoom level control module to the client zoom level manager module running on client computing device in the zoom level response if they are found; and
using the received preferred zoom level settings by the client zoom level manager module to adjust the browser zoom level so that the preferred zoom level is used to display the web page;
interacting with the web page displayed in the web browser using a properly configured zoom level.
